(19) United States
(12) Patent Application Publication
(10) Pub. No.: US 2024/0362774 A1
(43) Pub. Date: Oct. 31, 2024

(54) MEDICAL IMAGE PROCESSING APPARATUS AND METHOD

(71) Applicant: CANON MEDICAL SYSTEMS CORPORATION, Otawara-shi (JP)

(72) Inventor: Keith GOATMAN, Edinburgh (GB)

(73) Assignee: CANON MEDICAL SYSTEMS CORPORATION, Otawara-shi (JP)

(21) Appl. No.: 18/309,029

(22) Filed: Apr. 28, 2023

(51) Int. Cl. G06T 7/00; G06T 5/00; G06T 11/00; G06V 10/25

(52) U.S. Cl. CPC G06T 7/0012; G06T 5/77; G06T 11/003; G06V 10/25; G06T 2207/10072; G06T 2211/441

(57) ABSTRACT

A medical image processing apparatus comprising processing circuitry configured to: receive computed tomography (CT) perfusion image data that is representative of an anatomical region of a patient or other subject, determine or define a region of interest of the anatomical region, in-paint one or more parts of the anatomical region, the one or more parts being located inside and/or outside of the region of interest and perform low-pass filtering of at least the region of interest to generate filtered CT perfusion image data.

### FIELD

The present invention relates to a medical image processing apparatus, a medical image processing method and a method of detecting a defect or abnormality in an anatomical structure or organ.

### BACKGROUND

Computed tomography (CT) perfusion is an imaging technique that may be used to obtain perfusion images of one or more organs of a patient or other subject. Another imaging technique that may be used to obtain perfusion images of one or more organs of a patient or other subject may include single-photon emission computerised tomography (SPECT).

For example, CT and/or SPECT may be used to obtain perfusion images of the lungs of the patient or other subject. The obtained perfusion images may be used to diagnose a medical condition or disease of the lungs of the patient or other subject. An exemplary medical condition of the lungs of the patient or other subject that may be diagnosed using perfusion images includes pulmonary hypertension. However, it can be difficult or impossible to distinguish between different forms of pulmonary hypertension using only CT. For example, perfusion images obtained by SPECT may be necessary to diagnose a form of pulmonary hypertension, such as chronic thromboembolic pulmonary hypertension. This form of pulmonary hypertension is considered to be rare but curable.

However, an acquisition time of perfusion images using SPECT is generally longer than an acquisition time of perfusion images using CT. For example, CT perfusion images may be acquired in less than a second. As such, movement of the patient or other subject, e.g. due to breathing, may have less of an impact on the perfusion images acquired using CT compared to SPECT.

Generally, SPECT perfusion images have a lower resolution, but higher signal-to-noise ratio and a higher contrast than CT perfusion images. In perfusion images acquired by SPECT, it may be possible to detect a perfusion signal up to an edge or periphery of the lungs. Perfusion images acquired by CT have a higher resolution, but a lower signal-to-noise ratio compared to perfusion images acquired by SPECT.

In addition, when the lungs of the patient or other subject are imaged, the CT perfusion images often includes vessels and/or other anatomical structures of the lungs and/or heart, which may be distracting and/or not desirable. It may also not be possible to detect the perfusion signal up to the edge or periphery of the lungs when using CT. As CT is more widely available in hospitals or other medical facilities than SPECT, less expensive than SPECT and/or CT perfusion images can be more quickly acquired than SPECT perfusion images, it may be desirable to improve a quality of CT perfusion images.

### DESCRIPTION

Embodiments are now described by way of non-limiting example with reference to the accompanying drawings in which:

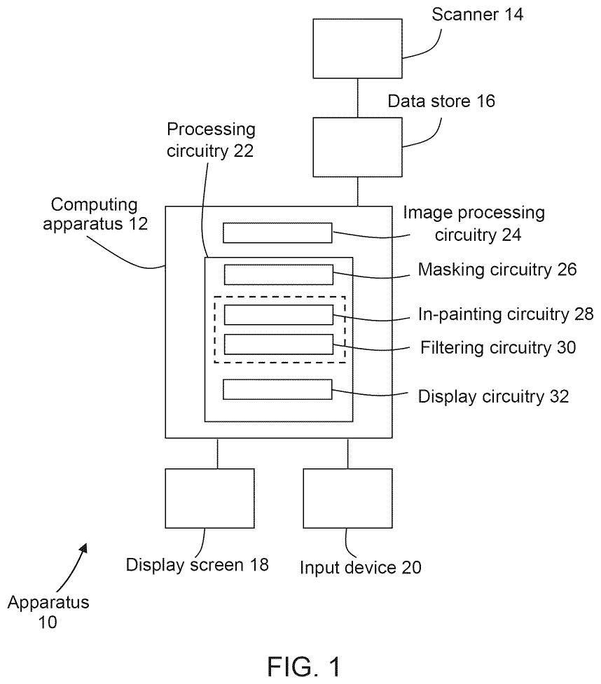

FIG. 1 is a schematic illustration of a medical image processing apparatus according to an embodiment;

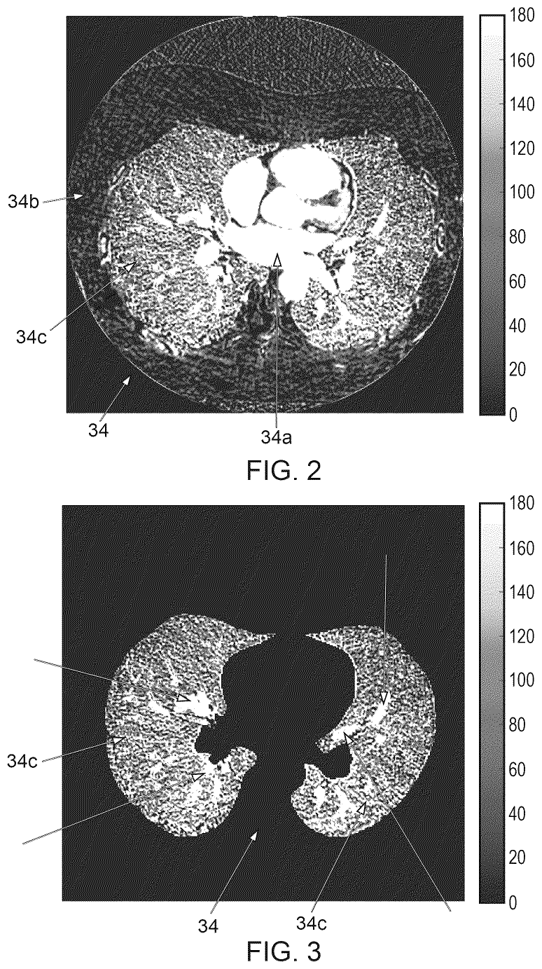

FIG. 2 illustrates a two-dimensional image of an anatomical region of a patient or other subject;

FIG. 3 illustrates a two-dimensional image of the anatomical region of FIG. 2 with a lung mask applied;

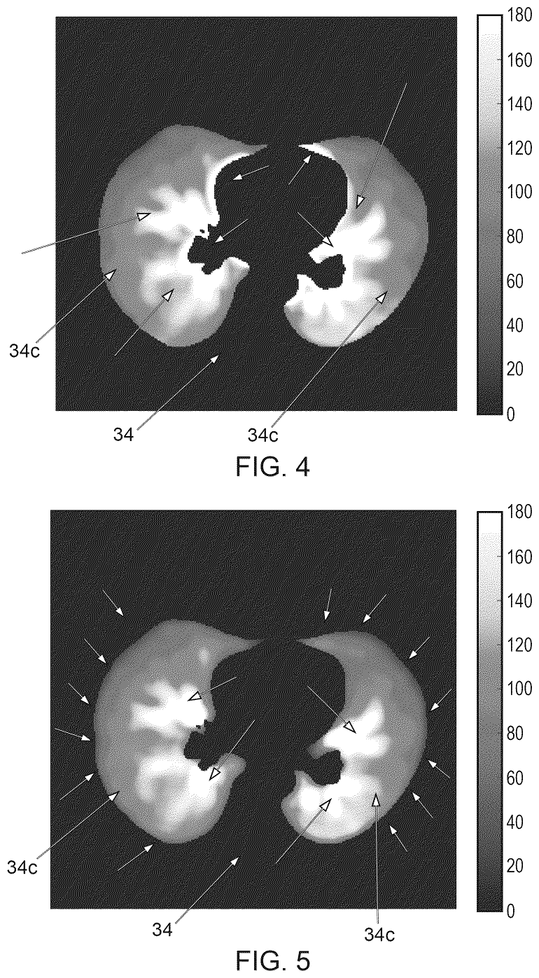

FIG. 4 illustrates a two-dimensional image of the anatomical region of FIG. 2 to which a low-pass filter has been applied;

FIG. 5 illustrates a two-dimensional image of the anatomical region of FIG. 2 to which the lung mask and a low-pass filter has been applied;

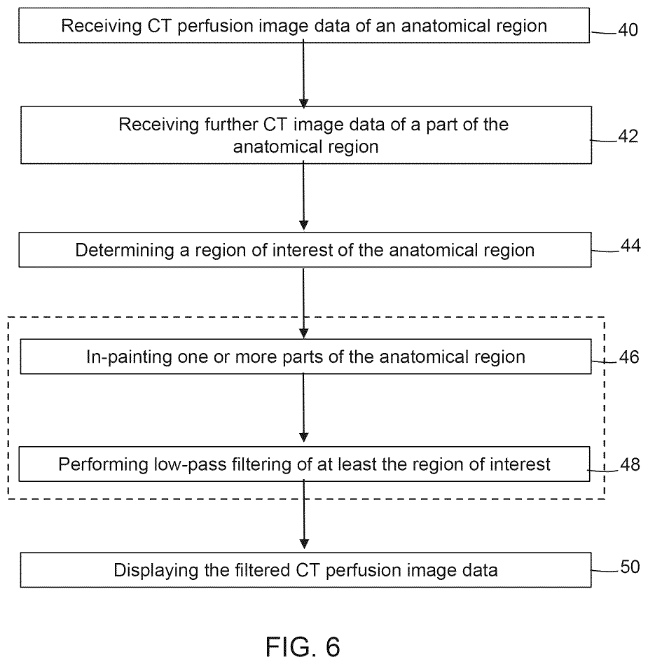

FIG. 6 is a flow chart illustrating in overview a process of an embodiment;

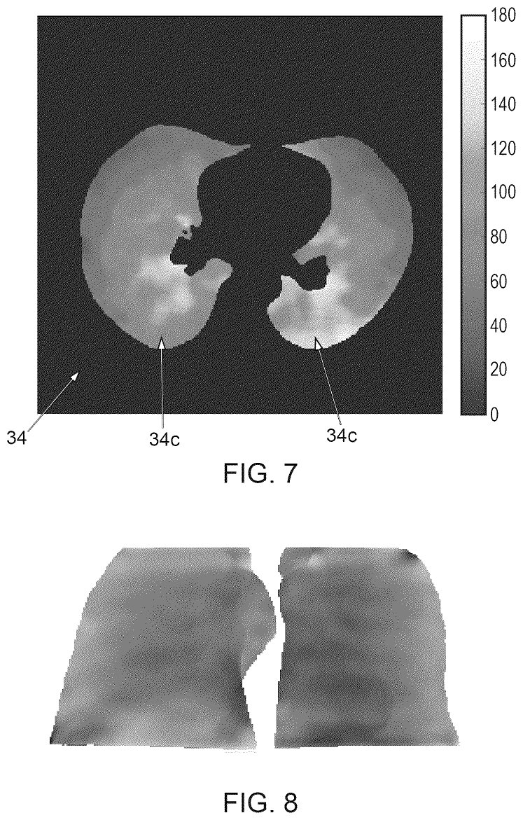

FIG. 7 illustrates a two-dimensional image of the anatomical region of FIG. 2 that has been processed using the process of FIG. 6;

FIG. 8 illustrates an anterior ventilation-perfusion VQ image of a lung parenchyma region that has been generated by the processing apparatus of FIG. 1;

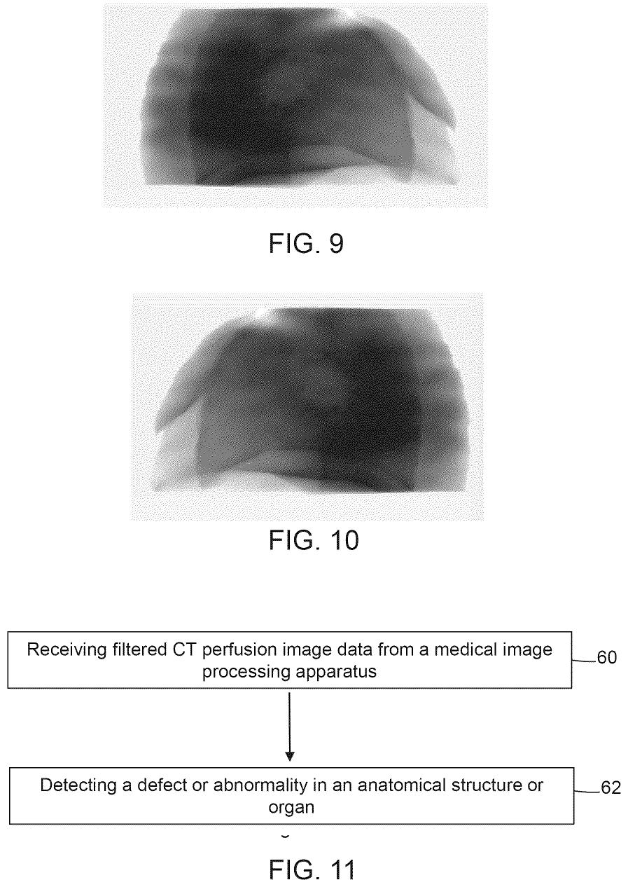

FIG. 9 illustrates a left anterior oblique VQ image of the lung parenchyma region that has been generated by the processing apparatus of FIG. 1;

FIG. 10 illustrates a left posterior oblique VQ image of the lung parenchyma region that has been generated by the processing apparatus of FIG. 1; and

FIG. 11 is a flow chart illustrating in overview a method of detecting a defect or abnormality in an anatomical structure or organ of a patient or other subject according to an embodiment.

Certain embodiments provide a medical image processing apparatus comprising processing circuitry configured to: receive computed tomography (CT) perfusion image data that is representative of an anatomical region of a patient or other subject, determine or define a region of interest of the anatomical region, in-paint one or more parts of the anatomical region, the one or more parts being located inside and/or outside of the region of interest and perform low-pass filtering of at least the region of interest to generate filtered CT perfusion image data.

Certain embodiments provide a medical image processing method comprising receiving computed tomography (CT) perfusion image data that is representative of an anatomical region of a patient or other subject, determining or defining a region of interest of the anatomical region, in-painting one or more parts of the anatomical region the one or more parts being located inside and/or outside of the region of interest and performing low-pass filtering of at least the region of interest to generate filtered CT perfusion image data.

Certain embodiments provide a method of detecting a defect or abnormality in an anatomical structure or organ of a patient or other subject, the method comprising receiving filtered CT perfusion image data that is representative of the anatomical structure of organ of the patient or other subject from a medical image processing apparatus according to an embodiment described herein, detecting the defect or abnormality in the anatomical structure or organ using at least one of a trained machine learning model and/or image processing circuitry configured to detect one or more parts of the anatomical structure or organ that exhibit perfusion below a threshold that is associated with an adequate level of perfusion.

A medical image processing apparatus 10 according to an embodiment is schematically illustrated in FIG. 1. The medical image processing apparatus 10 comprises a computing apparatus 12, which may be provided in the form of a personal computer or workstation. In this embodiment, the computing apparatus 12 is connected to a scanner 14, e.g. via a data store 16. However, it will be appreciated that in other embodiments, the medical image processing apparatus may not be connected or coupled to any scanner.

The medical image processing apparatus 10 further comprises one or more display screens 18 and an input device or devices 20, such as a computer keyboard, mouse or trackball.

In the present embodiment, the scanner 14 is a computed tomography (CT) scanner. The scanner 14 is configured to generate image data that is representative of an anatomical region of a patient or other subject.

In the present embodiment, image data sets obtained by the scanner 14 are stored in the data store 16 and subsequently provided to the computing apparatus 12. In an alternative embodiment, image data sets may be supplied from a remote data store (not shown). The data store 16 or remote data store may comprise any suitable form of memory storage.

The computing apparatus 12 comprises a processing circuitry 22 for processing of data. The processing circuitry comprises a central processing unit (CPU) and Graphical Processing Unit (GPU). The processing circuitry 22 provides a processing resource for automatically or semi-automatically processing medical image data sets. In other embodiments, the data to be processed may comprise any image data, which may not be medical image data.

In the present embodiment, computing apparatus 12 includes image processing circuitry 24 configured for generating CT perfusion image data. The CT perfusion image data may also be referred to as CT iodine concentration maps, iodine map image or contrast image data.

In some embodiments, the CT perfusion image data may comprise image data obtained from subtraction CT. For example, the image processing circuitry 24 may be configured to subtract non-contrast CT image data from contrast-enhanced CT image data. The non-contrast CT image data may be generated by the scanner 14 prior to administering a contrast agent, such as an iodine-based contrast agent or the like, to the patient or other subject. The contrast-enhanced CT image data may be generated by the scanner 14 subsequent to administering the contrast agent to the patient or other subject. This process may also be referred to a pre/post contrast subtraction method or subtraction.

In some embodiments, the CT perfusion image data may comprise image data obtained from dual-energy CT. Dual-energy CT image data by may be generated by the scanner 14 using two different energy levels. This process may also be referred to as a dual energy method or dual energy scan. The image processing circuitry 24 may be configured to generate CT perfusion image data based on the dual-energy CT image data generated by the scanner 14. It will be appreciated that in other embodiments, the CT perfusion image data may be generated by an image processing circuitry of a different computing device and been stored in the data store.

The CT perfusion image data may comprise a three-dimensional (3D) array of voxels. Each voxel is representative of a particular position in three-dimensional space. Each voxel has an associated intensity value that is representative of an attenuation of the applied X-ray radiation provided at the location represented by the voxel. The CT perfusion image data may also be referred to as 3D CT perfusion image data.

The processing circuitry 22 includes masking circuitry 26, in-painting circuitry 28, filtering circuitry 30 and display circuitry 32, which will be described below in more detail.

In the present embodiment, the circuitries 24, 26, 28, 30, 32 are each implemented in the CPU and/or GPU by means of a computer program having computer-readable instructions that are executable to perform one or more operations of the medical image processing apparatus 10 and/or a medical image processing method of an embodiment described herein. In some embodiments, the in-painting circuitry 26 and the filtering circuitry 28 may be implemented in the CPU and/or GPU by means of a single computer program having computer-readable instructions that are executable to perform at least some operations of the medical image processing apparatus 10 and/or at least some steps of the medical image processing method. In other embodiments, the circuitries may be implemented as one or more ASICs (application specific integrated circuits) or FPGAs (field programmable gate arrays).

The computing apparatus 12 also includes a hard drive and other components of a PC including RAM, ROM, a data bus, an operating system including various device drivers, and hardware devices including a graphics card. Such components are not shown in FIG. 1 for the sake of clarity.

The processing circuitry 12 is configured to receive CT perfusion image data that is representative of an anatomical region of the patient or other subject. For example, the processing circuitry 22 may be configured to receive the CT perfusion image data from the image processing circuitry 24 or the data store 16.

FIG. 2 illustrates a two-dimensional (2D) image of the anatomical region 34 of the patient or other subject. The display circuitry 32 may be configured to display the 2D image obtained from the CT perfusion image data to a user. For example, the 2D image may comprise a 2D slice through 3D CT perfusion image data. It will be understood that the term “2D image” as used herein may encompass a 2D slice through the 3D CT perfusion image data.

In this embodiment, the 3D CT perfusion image data has been obtained from subtraction CT. The 2D image is provided in the form of a 2D perfusion image showing a perfusion signal of different structures or parts of the anatomical region 34. For example, the perfusion signal associated with one or more structure or parts of the anatomical region 34 that have a high perfusion may have a higher intensity than the perfusion signal associated with structure or parts of the anatomical regions that have a low or no perfusion.

In this embodiment, the anatomical region 34 comprises a chest region of the patient or other subject. The chest region may comprise one or more organs, such as the lungs and heart, and/or other anatomical structures, such as the ribs, of the patient or other subject. The anatomical region 34 comprises a vessel region 34a, which includes at least one vessel of the lung, e.g. the pulmonary vein, one or more vessels of the heart, e.g. the ascending and descending aorta, and parts of the chambers of the heart, e.g. the left and right atrium and the right ventricular outflow tract. The anatomical region 34 also comprises a chest wall region 34b and a lung parenchyma region 34c.

The 2D image of the anatomical region 34 illustrated in FIG. 2 includes noise, which may make it difficult to detect gradients in the perfusion signal and/or a defect or abnormality of the lung parenchyma region 34c. In addition, the vessel region 34a has an increased perfusion signal, e.g. an increased brightness, relative to other parts of the anatomical region 34. The increased brightness of the vessel region 34a may be considered distracting and/or make a reduction of the noise, e.g. due to filtering, difficult.

The processing circuitry 22 is configured to determine or define a region of interest of the anatomical region 34. In this embodiment, the region of interest comprises the lung parenchyma region 34c of the patient or other subject. The region of interest may also be referred to a tissue of interest or tissue region. In some embodiments, the processing circuitry 22 is configured to perform a first masking process to mask the region of interest of the anatomical region 34. The first masking process can be used to determine or define a region of the CT perfusion image data, e.g. the region of interest, that will be processed further. For example, the processing circuitry 22 may be configured to convolute the CT perfusion image data with a mask of the region of interest of the anatomical region 34. The masking circuitry 26 may be configured to perform the first masking process.

FIG. 3 illustrates a 2D image of the anatomical region 34 with the lung mask applied to the CT perfusion image data. As can be seen in FIG. 3, only the lung parenchyma region 34c is visible. In this embodiment, the masking circuitry 26 has masked the lung parenchyma region 34c and set an intensity value of one or more pixels outside the region of interest of the anatomical region 34 to zero. However, it will be appreciated that in other embodiments, the masking circuitry may not set the pixel values outside of the region of interest. For example, in such other embodiments, the masking circuitry may maintain an original value of the one or more pixels outside the region of interest. The first masking process may be considered as applying a lung mask to the CT perfusion image data.

It can be seen from FIG. 3 that the lung parenchyma region 34c includes a number of anatomical structures with an increased perfusion signal, e.g. an increased brightness, relative to one or more other parts of the lung parenchyma region 34c. The anatomical structures comprise one or more vessels of the lung parenchyma region 34c, which are indicated in FIG. 3 by the arrows. These vessels of the lung parenchyma region 34c may also be referred to as vessel regions. For sake of clarity only five arrows are shown in FIG. 3. The vessels with the increased perfusion signal may be larger than a plurality of other vessels in the lung parenchyma region 34c and as such, exhibit the increased perfusion signal relative to the other vessels.

FIG. 4 illustrates a 2D image of the anatomical region 34 to which a low-pass filter has been applied. For example, the CT perfusion image data has been convoluted with a 3D Gaussian filter function. In this example, no lung mask has been applied to the CT perfusion image data. However, the vessel region 34a and the chest wall region 34b have been omitted from FIG. 4 for sake of clarity.

It can be seen from FIG. 4 that the application of the low-pass filter has increased an area of the vessels of the lung parenchyma region 34c with the increased perfusion signal that are visible in FIG. 3. Expressed differently, the perfusion signal of these vessels has been smeared in FIG. 4, which is indicated by the arrows in FIG. 4. Additionally, as no lung mask has been applied to the CT perfusion image data, the application of the low-pass filter has introduced a number of artefacts with an increased signal along a periphery of a part of the lung parenchyma region 34c that surrounds the vessel region 34a.

FIG. 5 illustrates a 2D image of the anatomical region 34 to which the lung mask and the low-pass filter has been applied. In this example, the lung mask was applied to reduce and/or avoid artefacts due to the vessel region 34a and/or the chest wall region 34b. It can be seen from FIG. 5 that the application of the low-pass filter has smeared the perfusion signal of the vessels of the lung parenchyma region 34c that are visible in FIG. 3. Additionally, a brightness along a periphery of a part of the lung parenchyma region 34c that is surrounded by the chest wall region 34b has decreased. This may be due to averaging of the perfusion signal of the lung parenchyma region 34c with the relatively lower perfusion signal of the chest wall region 34b, when applying the low-pass filter. As such, it may not be possible to detect the perfusion signal up to the edge or periphery of the lung parenchyma region 34c. However, the artefacts along the periphery of the part of the lung parenchyma region 34c that surrounds the vessel region 34a, as shown in FIG. 4, have been removed.

FIG. 6 is a flow chart illustrating in overview the process of an embodiment.

At a first stage 40, the processing circuitry 22 is configured to receive the CT perfusion image data that is representative of the anatomical region 34 of the patient, as described above.

In embodiments where the received CT perfusion image data includes a clear and/or distinct boundary between the vessel region 34a and the lung parenchyma region 34c and between the chest wall region 34b and the lung parenchyma region 34c, the CT perfusion image data is received as a single input.

In embodiments where the CT perfusion image data received by the processing circuitry 22 does not include a clear and/or distinct boundary between the vessel region 34a and the lung parenchyma region 34c and/or between the chest wall region 34b and the lung parenchyma region 34c, at stage 42, the processing circuitry 22 is configured to receive further CT image data that is representative of the anatomical region 34 of the patient or other subject. The further CT image data may comprise CT image data in which at least a part of the anatomical region 34 can be distinguished from one or more other parts of the anatomical region 34. In this embodiment, the further CT may comprise non-contrast CT image data of the anatomical region 34. However, it will be appreciated that in other embodiments, the further CT image data may comprise further CT perfusion image data. In this embodiment, the part of the anatomical region 34 comprises the lung parenchyma region 34c. However, in other embodiments, the part of the anatomical region 34 may comprise the vessel region 34a and/or one or more vessels of the lung parenchyma region.

At stage 44, the processing circuitry 22 is configured to determine or define the region of interest of the anatomical region 34. As described above, in some embodiments, the first masking process may be used to determine or define the region of interest, which comprises the lung parenchyma region 34c. For example, the processing circuitry 22 may be configured to convolute the CT perfusion image data with the mask of the region of interest. In such embodiments, the masking circuitry 26 is configured to perform the first masking process to mask the region of interest. As described above, first masking process may be considered as applying the lung mask to the CT perfusion image data.

In some embodiments, the masking circuitry 26 is configured to perform a second masking process. In such embodiments, the masking circuitry 26 is configured to perform a second masking process to mask one or more parts of the anatomical region 34 located inside and/or outside of the region of interest. The one or more parts may also be referred to as a region.

In some embodiments, the processing circuitry 22 is configured to determine or define the one or more parts of the anatomical region 34 located inside and/or outside of the region of interest. For example, the one or more parts of the anatomical region 34 located inside the region of interest may comprise one or more vessels of the lung parenchyma region 34c. These vessels of the lung parenchyma regions 34c may have an increased perfusion signal, e.g. brightness relative, to other parts of the anatomical region 34, as illustrated in FIG. 3. The processing circuitry 22 may use a vessel tracking model or algorithm or like to detect these vessels in the lung parenchyma region 34c. In this embodiment, the vessel tracking model or algorithm may include a three-dimensional vesselness filter, such as a Frangi filter or the like, which may be used in combination with a pre-determined perfusion signal threshold. It will be appreciated that in other embodiments, the vessel tracking model or algorithm may be differently implemented. For example, in other embodiments, the vessel tracking model or algorithm may comprise a machine learning model or algorithm. The machine learning algorithm may comprise a neural network, such as an artificial or simulated neural network, that has been trained to detect the vessels in the lung parenchyma region 34c that have an increased perfusion signal. In some embodiments, the masking circuitry 26 is configured to mask the one or more vessels of the lung parenchyma region 34c.

The one or more parts located outside the region of interest may comprise the vessel region 34a. As illustrated in FIG. 2, the vessel region 34a is located outside of the lung parenchyma region 34c. In some embodiments, the masking circuitry 26 is configured to mask the vessel region 34a.

As such, the second masking process may be used to determine or define a further region of the CT perfusion image data, which in this embodiment comprises the vessel region 34a and/or the vessels of the lung parenchyma region 34c with the increased perfusion signal, that will be processed further. For example, the masking circuitry 26 may be configured to convolute the CT perfusion image data with a mask of the vessel region 34a and/or a mask of the vessels of the lung parenchyma region 34c with the increased perfusion signal.

In embodiments where the CT perfusion image data received by the processing circuitry 22 includes a clear and/or distinct boundary between the vessel region 34a and the lung parenchyma region 34c and between the chest wall region 34b and the lung parenchyma region 34c, the masking circuitry 26 may use this CT perfusion image data to perform the first and/or second masking processes. For example, in embodiments where the CT perfusion image data is received as a single input, the masking circuitry 26 is configured to mask the lung parenchyma region 34c, e.g. the region of interest, the vessel region 34a and/or the vessels of the lung parenchyma region 34c with the increased perfusion signal based on the CT perfusion image data. However, in embodiments where the CT perfusion image data received by the processing circuitry 22 does not include a clear and/or distinct boundary between the vessel region 34a and the lung parenchyma region 34c and between the chest wall region 34b and the lung parenchyma region 34c, the masking circuitry 26 is configured to perform the first and/or second masking processes based on the CT perfusion image data and the further CT image data received by the processing circuitry 22. For example, the masking circuitry 26 may be configured to generate the mask of the region of interest, e.g. the lung mask, and/or the mask of the one or more parts of the anatomical region 34 located inside and/or outside of the region of interest, e.g. the vessel region 34a and/or the vessels of the lung parenchyma region 34c with the increased perfusion signal, using the further CT image data. The masking circuitry 26 may then apply the generated mask of the region of interest and/or the generated mask of the one or more parts of the anatomical region 34 located inside and/or outside of the region of interest to the CT perfusion image data.

It will be appreciated that in some embodiments, the masking circuitry is configured to only perform the first masking process or the second masking process.

At stage 46, the processing circuitry is configured to in-paint the one or more parts of the anatomical region. As described above, the processing circuitry 22 comprises the in-painting circuitry 28. The in-painting circuitry 28 may be configured to in-paint the one or more parts of the anatomical region 34. The in-painting circuitry 28 may be configured to in-paint the one or more parts of the anatomical region 34 based on one or more pixels surrounding or neighbouring the one or more parts of the anatomical region 34. For example, the in-painting circuitry 28 may be configured to interpolate one or more pixel values of the one or more parts of the anatomical region 34 based on the values of the one or more pixels surrounding or neighbouring the one or more parts of the anatomical region 34. The in-painting circuitry 28 may be configured to replace the pixel values of the one or more parts of the anatomical region 34 with the interpolated pixel values. An exemplary in-painting method that may be used by the in-painting circuitry 28 is described in Bornemann et al. “Fast Image Inpainting based on Coherence Transport,” Journal of Mathematical Imaging and Vision 28, 259-278 (2007). However, it will be appreciated that other in-painting methods may be used by the in-painting circuitry 28.

In some embodiments, the in-paint circuitry 28 is configured to in-paint the one or more parts of the anatomical region that have been masked in the second masking process performed by the masking circuitry 26. In other embodiments, the in-painting circuitry 28 is configured to in-paint the one or more parts of the anatomical structure that are located inside the region of interest. In such other embodiments, only the first masking process has been performed by the masking circuitry 26.

At stage 48, the processing circuitry 22 is configured to perform low-pass filtering of at least the region of interest to generate filtered CT perfusion image data. Filtered CT perfusion image data may also be referred to as corrected CT perfusion image data. As described above, the processing circuitry 22 comprises the filtering circuitry 30, which is configured to perform the low-pass filtering of at least the region of interest.

In this embodiment, the filtering circuitry 30 is configured to convolve the in-painted CT perfusion image data of the anatomical region 34 with a filter function. For example, the convolution g for a one-dimensional signal f convolved with the filter function h at position x is given by:

$$g ( x ) = [ f * h ] = {Σ}_{y ∈ h} f ( x - y ) h ( y ) \qquad ( Equation 1 )$$

The filter function h sums to unity across its extent, so that the filter function h does not change an average value of each pixel of the anatomical region 34, but applies a local smoothing. The filter function h may also be referred to as a filter kernel. Although Equation 1 refers to a one-dimension signal f, it will be understood that the filtering circuitry 30 may be configured to convolute the 3D CT perfusion image data with the filter function h, which in this embodiment comprises a 3D Gaussian filter function. The use of the 3D Gaussian filter function may prevent frequency domain ripples. As such, the use of the 3D Gaussian filter function may reduce or avoid artefacts being introduced in the filtered CT perfusion image data. However, it will be appreciated that in other embodiments, another filter function may be used, such as a Butterworth filter function, a Chebyshev filter function, a Metz filter function, Wiener filter function and/or the like. In this embodiment, stages 46 and 48 of the process are sequentially performed. It will be appreciated that in other embodiments, low-pass filtering may be applied to the region of interest only.

In some embodiments, stages 46 and 48 of the process are simultaneously performed. This is indicated by the dashed box in FIG. 6. In such embodiments, the filtering circuitry 30 may be configured to convolve the CT perfusion image data of the region of interest M with a filter function h, which may also be referred to as a filter kernel. The convolution g for a one-dimensional signal f convolved with the filter function h at position x is given by:

$${g}_{x} = [ f * h \vert M ] ( x ) = \frac{{Σ}_{y ∈ h ⋂ M} F ( x - y ) h ( y )}{{Σ}_{y ∈ h ⋂ M} h ( y )} \qquad ( Equation 2 )$$

However, only pixel values that intersect with the region of interest M are included in the summation. The denominator of Equation 2 normalises the filter function h to unity based on the intersection with the region of interest M. The convolution g is only valid for pixel values in the convolution summation that intersect the region of interest M. As such, the convolution may be referred to as a conditional convolution and/or the in-paining and low-pass filtering processes are only performed for the region of interest. An extent of the filter function h, e.g. the filter kernel, is selected to be larger than an extent or dimension of the parts of the anatomical structure that are to be in-painted. The extent of the filter function h, e.g. the filter kernel, may also be understood as a dimension of the filter function h, e.g. the filter kernel.

Although Equation 2 refers to a one-dimension signal f, it will be understood that the filtering circuitry 30 may be configured to convolute the 3D CT perfusion image data with the filter function h, which in this embodiment comprises a 3D Gaussian filter function. However, as described above, in other embodiments another filter function may be used. The region of interest M comprises the lung parenchyma region 34c. As such, the masking circuitry 26 may be configured to perform the first masking process to apply the lung mask, as described above. The second masking process is not necessary in this embodiment.

At stage 50, the processing circuitry 22 is configured to display the filtered CT perfusion image data. For example, the display circuitry 32 may be configured to display the filtered CT perfusion image data. However, it will be appreciated that in some embodiments, the filtered CT perfusion image data may not be displayed. For example, in such other embodiments, the filtered CT perfusion image data may be further processed, stored and/or transmitted to another computing apparatus.

FIG. 7 illustrates a 2D image of the anatomical region of FIG. 2. The 2D image illustrated in FIG. 7 is a slice of 3D CT perfusion image data that has been processed using the process illustrated in FIG. 6. The 2D image illustrated in FIG. 7 has been processed by the processing circuitry 22 using Equation 2. It can be seen from FIG. 7, that any artefacts, e.g. due to the vessel region 34a and/or the chest wall region 34b have been removed. In addition, perfusion can be detected up to the periphery of the lung parenchyma region 34c. A gradient in the brightness of the lung parenchyma region 34c, extending from the top to the bottom of the 2D image, is visible in FIG. 7. This gradient may be due to the patient's being in a supine position during the acquisition of the CT perfusion image data. The 2D image illustrated in FIG. 7 may also be referred to as a filtered 2D image.

By configuring the processing circuitry to in-paint the one or more parts of the anatomical region and to perform low-pass filtering of the region of interest, a signal to noise ratio may be improved or increased, artefacts and/or smearing of the perfusion signal e.g. due to the vessel region 34a, the chest wall region 34b and/or the larger vessels in the lung parenchyma region 34c, may be removed and/or the detection of the perfusion signal up to the periphery of the region of interest may be possible. As such, a quality of the filtered CT perfusion image data may be improved compared to the CT perfusion image data received by the processing circuitry 22. The filtered CT perfusion image data may facilitate the detection and/or the differentiation of perfusion defects of the lung parenchyma region 34. For example, the filtered CT perfusion image data may facilitate the differentiation between different forms of pulmonary hypertension. This in turn may allow for the detection of a rare and/or curable form of pulmonary hypertension, such as chronic thromboembolic pulmonary hypertension, using CT only.

FIG. 8 illustrates a generated anterior ventilation-perfusion VQ image of the lung parenchyma region. FIG. 9 illustrates a generated left anterior oblique VQ image of the lung parenchyma region. FIG. 10 illustrates a generated left posterior oblique VQ image of the lung parenchyma region. VQ images are generally obtained using SPECT However, in some embodiments, the processing circuitry 22 may be configured to generate a VQ image based on the filtered CT perfusion image data. The V/Q image may also be referred to as a nuclear medicine V/Q scan view. For example, the processing circuitry 22 may be configured to project filtered CT perfusion image data on a selected image plane, e.g. to create a VQ image for the selected image plane. In other words, the VQ images shown in FIGS. 8 to 10 may be considered as 2D projection images of the filtered CT perfusion image data.

FIG. 11 is a flow chart illustrating in overview a method of detecting a defect or abnormality, e.g. a pathological defect or abnormality, in an anatomical structure or organ of a patient or other subject. The defect may also be referred to as a perfusion defect.

At stage 60, filtered CT perfusion image data that is representative of the anatomical structure or the organ of the patient or other subject is received from the medical image processing apparatus 10.

At stage 62, the defect or abnormality in the anatomical structure or organ is detected.

In some embodiments, the defect or abnormality may be detected using a machine learning algorithm. The machine learning algorithm may include a supervised machine learning algorithm or system, such as a support vector machine, a convolutional neural network or the like. The machine learning algorithm may be trained to detect a defect or abnormality in the anatomical structure to organ. For example, the machine learning algorithm may be trained using previously filtered CT perfusion image data which may be representative of an anatomical region of each of a plurality of patients or other subjects. Some of the anatomical regions may comprise a defect or abnormality. Some other of the anatomical regions of the patients or other subjects may not comprise any defects or abnormalities.

In some embodiment, the defect or abnormality may be detected using an image processing circuitry, such as image processing circuitry 24 of computing apparatus 12 or an image processing circuitry of the another computing apparatus. The image processing circuitry may be configured to detect one or more parts of the anatomical structure or organ that exhibit perfusion below a threshold that is associated with an adequate level of perfusion. This in turn may be indicative of the defect or abnormality in the anatomical structure or organ. The processing circuitry may be configured to additionally perform a connected component analysis, e.g. to detect one or more objects or regions in the filtered CT perfusion image data that are formed from two or more connected pixels. For example, this may allow one or more objects or regions of the filtered CT perfusion image data that are below a particular size or size threshold to be removed and/or a number of defects or abnormalities to be counted. The one or more objects or regions that are to be removed may be due to noise or be insignificant, e.g. due to having a size below the particular size or size threshold.

Certain embodiments provide a medical imaging apparatus comprising processing circuitry configured to: receive measured CT iodine concentration maps by dual energy or pre/post contrast subtraction methods, determine which elements in the image are a tissue of interest, apply in-painting of plausible values in elements not the tissue of interest and apply low-pass filtering to improve signal-to-noise ratio of iodine map signal and provide iodine map values to the very edge of the tissue region. In-painting the non-tissue of interest elements and filtering may be sequential steps.

In-painting and filtering may be performed simultaneously by conditional convolution, e.g. conditioned on the elements determined to be the tissue of interest.

The tissue of interest may be lung parenchyma.

The output may be used to simulate traditional nuclear medicine V/Q scan views.

Certain embodiments provide an automated detection of perfusion defects from one or more methods disclosed herein using a threshold of adequate perfusion and connected-component analysis.

Certain embodiments provide an automated detection of perfusion defects from one or more methods disclosed herein using a trained machine learning system to identify perfusion defects.

Certain embodiments provide a medical image processing apparatus comprising processing circuitry configured to: receive CT perfusion image data, determine a region of interest included in the CT perfusion image data, generate masked CT perfusion image data by performing a first mask processing and a second mask processing to the CT perfusion image data, wherein the first mask processing masks a region excluding the region of interest in the CT perfusion image and the second mask processing masks vessel regions included in the region of interest, generate corrected CT perfusion image data by in-painting a masked region included in the region of interest, wherein the in-painting of the masked region is based on neighbor pixels of the masked region included in the masked CT perfusion image data.

The processing circuitry may be further configured to generate the corrected CT perfusion image data by performing a low pass filtering to the in-painted CT perfusion image data.

The CT perfusion image data may be contrast image data acquired by subtraction or dual energy scan.

The above description uses the term “pixel” in relation to 2D image data and the term “voxel” in relation to 3D image data. However, since one or more embodiments described herein may related and/or use 2D and/or 3D image data, these terms may be interchangeably used.

Whilst particular circuitries have been described herein, in alternative embodiments functionality of one or more of these circuitries can be provided by a single processing resource or other component, or functionality provided by a single circuitry can be provided by two or more processing resources or other components in combination. Reference to a single circuitry encompasses multiple components providing the functionality of that circuitry, whether or not such components are remote from one another, and reference to multiple circuitries encompasses a single component providing the functionality of those circuitries.

Whilst certain embodiments have been described, these embodiments have been presented by way of example only, and are not intended to limit the scope of the invention. Indeed the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms and modifications as would fall within the scope of the invention.

1. A medical image processing apparatus comprising processing circuitry configured to:
receive computed tomography (CT) perfusion image data that is representative of an anatomical region of a patient or other subject;
determine or define a region of interest of the anatomical region;
in-paint one or more parts of the anatomical region, the one or more parts being located inside and/or outside of the region of interest; and
perform low-pass filtering of at least the region of interest to generate filtered CT perfusion image data.

2. The apparatus according to claim 1, wherein the CT perfusion image data comprises perfusion image data obtained from a CT subtraction method or a dual-energy CT method.

3. The apparatus according to claim 1, wherein the processing circuitry is configured to in-paint the one or more parts of the anatomical region and perform the low-pass filtering of at least the region of interest sequentially.

4. The apparatus according to claim 1, wherein the processing circuitry is configured to in-paint the one or more parts of the anatomical region and perform the low-pass filtering of at least the region of interest simultaneously.

5. The apparatus according to claim 1, wherein the processing circuitry is configured to determine the one or more parts of the anatomical region prior to in-painting the one or more parts of the anatomical.

6. The apparatus according to claim 1, wherein the processing circuitry is configured to in-paint the one or more parts of the anatomical region based on one or more pixels surrounding or neighbouring the one or more parts of the anatomical region.

7. The apparatus according to claim 1, wherein the processing circuitry is configured to perform a first masking process to mask the region of interest.

8. The apparatus according to claim 1, the processing circuitry is configured to perform a second masking process to mask the one or more parts of the anatomical region that are located outside and/or inside of the region of interest.

9. The apparatus according to claim 8, wherein the processing circuitry is configured to in-paint the masked one or more parts of the anatomical region that are located outside and/or inside of the region of interest.

10. The apparatus according to claim 1, wherein the processing circuitry is configured to receive further CT image data that is representative of the anatomical region the patient or other subject.

11. The apparatus of claim 10, wherein the processing circuitry is configured to perform a first masking process to mask the region of interest and/or a second masking process to mask the one or more parts of the anatomical region that are located outside and/or inside of the region of interest based on the CT perfusion image data and the further CT image data.

12. The apparatus according to claim 1, wherein the processing circuitry is configured to perform the low-pass filtering using a three-dimensional Gaussian filter function.

13. The apparatus according to claim 1, wherein the region of interest comprises lung parenchyma of the patient or other subject.

14. The apparatus according to claim 13, wherein the one or more parts of the anatomical region that are located inside the region of interest comprise one or more vessels of the lung parenchyma.

15. The apparatus according to claim 1, wherein the one or more parts of the anatomical region that are located outside the region of interest comprise one or more vessels of a lung and/or a heart of the patient or other subject.

16. The apparatus according to claim 1, wherein the processing circuitry is configured to generate a two-dimensional image based on the filtered CT perfusion image data.

17. The apparatus according to claim 16, wherein the two-dimensional image comprises a ventilation-perfusion image.

18. A medical image processing method comprising:
receiving computed tomography (CT) perfusion image data that is representative of an anatomical region of a patient or other subject;
determining or defining a region of interest of the anatomical region;
in-painting of the one or more parts of the anatomical region, the one or more parts being located inside and/or outside of the region of interest; and
performing low-pass filtering of at least the region of interest to generate filtered CT perfusion image data.

19. A method of detecting a defect or abnormality in an anatomical structure or organ of a patient or other subject, the method comprising:
receiving filtered CT perfusion image data that is representative of the anatomical structure or the organ of the patient or other subject from a medical image processing apparatus according to claim 1;
detecting the defect or abnormality in the anatomical structure or organ using at least one of:
a trained machine learning model; and
an image processing circuitry configured to detect one or more parts of the anatomical structure or organ that exhibit perfusion below a threshold that is associated with an adequate level of perfusion.

20. The method of claim 19, wherein the image processing circuitry is configured to detect one or more objects or regions in the filtered CT perfusion image data that are formed from two or more connected pixels.
